(19) United States
(12) Patent Application Publication
(10) Pub. No.: US 2025/0366573 A1
(43) Pub. Date: Dec. 4, 2025

(54) ENGRAVABLE ADHESIVE DECORATIONS FOR VESSELS

(71) Applicant: Fayanna Smith, Johnsburg, IL (US)

(72) Inventor: Fayanna Smith, Johnsburg, IL (US)

(21) Appl. No.: 18/679,438

(22) Filed: May 30, 2024

(51) Int. Cl. A44C 3/00; A61G 17/08

(52) U.S. Cl. CPC A44C 3/002; A61G 17/08

(57) ABSTRACT

Engravable adhesive decorations comprising a decoration which can be curved to follow the surface geometry of an urn or similar vessel are disclosed. Improvements including removable accessories and screw-in image retainers are also disclosed.

### FIELD OF THE DISCLOSURE

This disclosure relates to engravable decorations which can be applied to vessels, for example commemorative cremation urns, and improvements to such engravable decorations.

### CROSS REFERENCE

None.

### BACKGROUND OF THE INVENTION

The present disclosure relates to engravable decorations, such as plaques or badges, designed to be affixed to vessels for the containment of ashes, more specifically human ashes to be kept in a vessel for commemorative or sentimental reasons. (For purposes of this application, such vessels shall be generally referred to as “urns,” though no particular shape or other feature is to be implied by the use of the general term.) Urns are an ancient tradition in human funerary rites, and over the centuries many innovative urns have been created to hold human ashes along with methods of decorating such urns. However, human experience is vast and diverse, and new ways to decorate urns allowing the expression of new kinds of respect and celebration of the deceased are always useful. There is a need for ways to decorate urns which are flexible, efficient, and usable with a wide variety of urns. The present disclosure addresses these concerns.

### SUMMARY OF THE INVENTION

According to an aspect of the disclosure, an engravable adhesive decoration for urns comprises a decoration body and a double-sided adhesive. The decoration body has an engravable area on a front side of the decoration body. The double-sided adhesive has a front side adhered to a rear side of the decoration body and an exposed rear side, the exposed adhesive rear side being operative to adhere to a surface of an urn to affix the decoration body to the urn.

### BRIEF DESCRIPTION OF THE DRAWINGS

FIG. 1 is a front view of an urn decoration according to an embodiment.

FIG. 2 is a front view of an urn decoration according to another embodiment.

FIG. 3 is a front view of an urn decoration according to another embodiment.

FIG. 4 is a rear view of the urn decoration shown in FIG. 3.

FIG. 5 is a front view of an urn decoration according to another embodiment.

FIG. 5a is a front view of an affixable engravable member of the urn decoration of FIG. 5.

FIG. 6 is a top or bottom plan view of an urn decoration according to embodiments.

FIG. 7 is a front view of an urn with an urn decoration affixed thereto according to an embodiment.

FIG. 8 is a side view of the urn with the urn decoration affixed thereto as in FIG. 7.

### DETAILED DESCRIPTION

Reference will now be made in detail to several embodiments of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, can be used with respect to the drawings. These and similar directional terms are not to be construed to limit the scope of the invention in any manner. The words attach, connect, couple, and similar terms with their inflectional morphemes do not necessarily denote direct or intermediate connections, but can also include connections through mediate elements or devices.

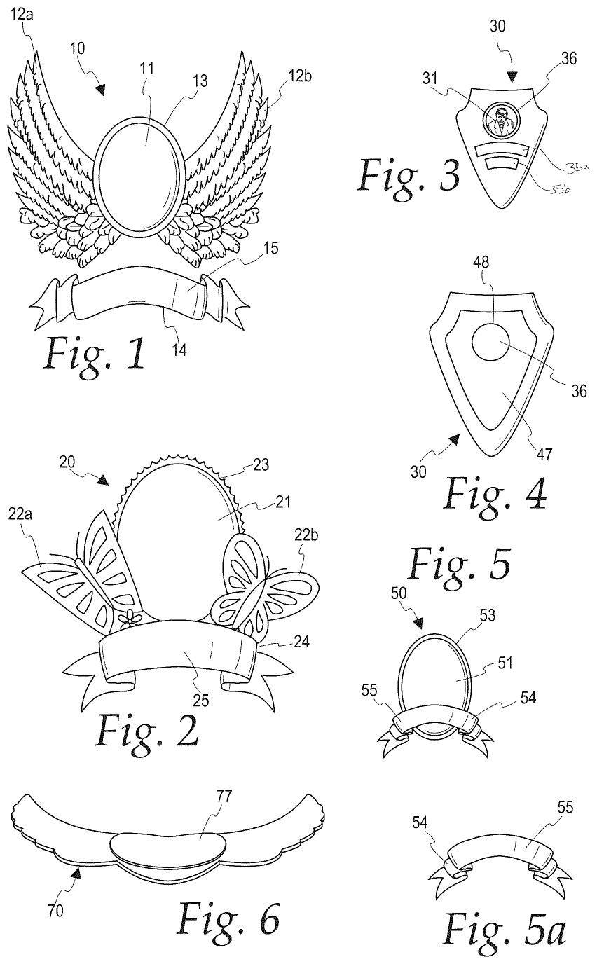

Affixable decorations according to various embodiments as shown in FIGS. 1-5, 5a, and 6 are now described in detail.

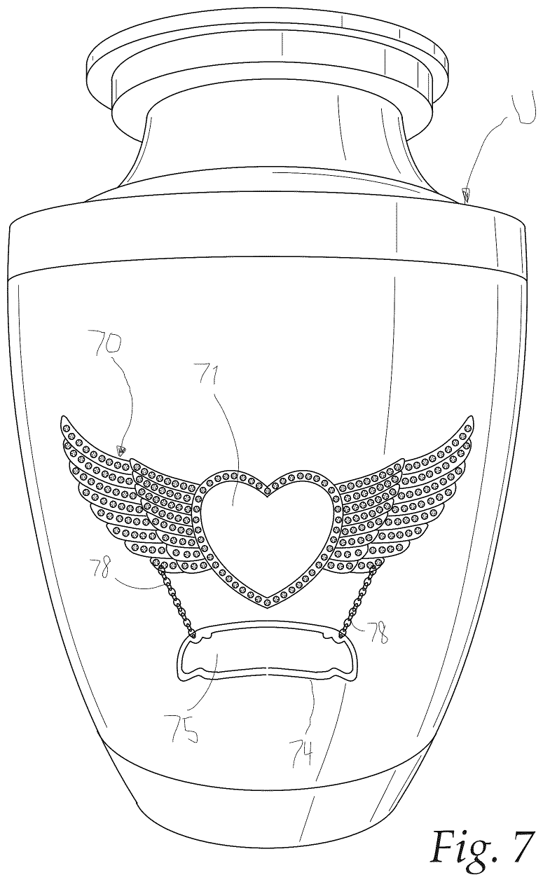

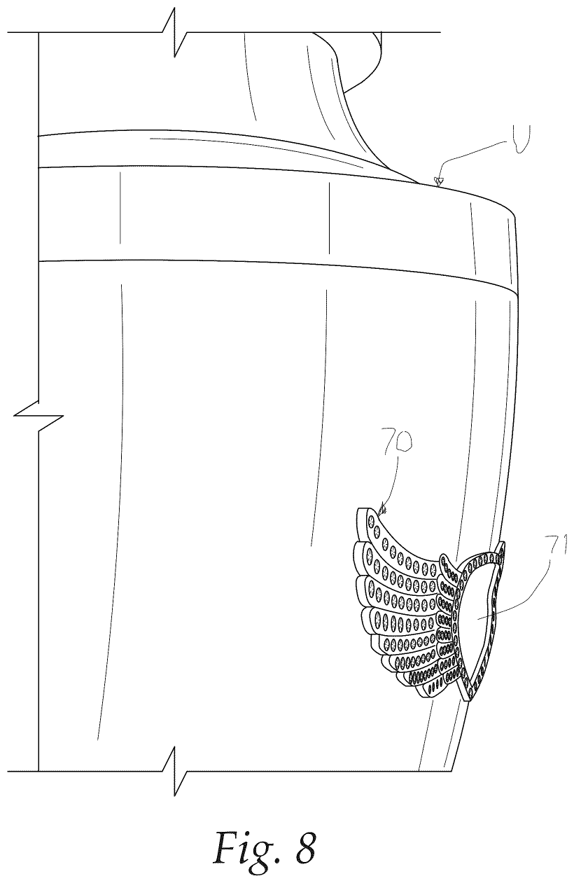

A decoration 10 according to an embodiment is shown in FIG. 1. Decoration 10 comprises photo area 11 surrounded by ring 13. Connected to ring 13 are wings 12a and 12b, and connected to the wings 12a, 12b is an engravable member 14 which has an engravable area 15. Decoration 10, as a whole, is curved so that its rear side (not shown) conforms or otherwise interfaces with the surface geometry of an urn, analogously to the decoration 70 shown in FIG. 6, as illustrated in FIGS. 7 and 8. A photo (not shown) may be affixed to photo area 11, and engraving may be performed on engravable area 15. In a method according to an embodiment, affixation of the photo in the photo area 11 and engraving on engravable area 15 are performed before decoration 10 is affixed to the urn. This allows for much easier and more efficient addition of the photo and engraving.

A decoration 20 according to another embodiment is shown in FIG. 2. The decoration 20 has a ring 23 that surrounds a photo area 21. Butterflies 22a and 22b of different sizes and/or shapes are connected to the ring 23 at opposite sides of the photo area 21, demonstrating that decoration 20 need not be symmetrical and can be of any desired configuration so long as it allows the proper geometry to interface with the surface of the urn.

A decoration 30 according to another embodiment is shown in FIG. 3. The decoration 30 is a single planar surface with no openings or discontinuities. Engravable areas 35a and 35b allow for engraving of the decoration. A photo plaque 36 comprises an insert which can have a photo or illustration 31 attached to its front side, and photo plaque 36 is then affixed to decoration 30 from the rear (see FIG. 4). Shown in FIG. 4 is the rear side of the decoration 30. Photo plaque 36 screws into decoration 30 via threads 48. An adhesive 47 is then used to secure the decoration 30 to an urn.

Illustrated in FIGS. 5 and 5a is a decoration 50 according to another embodiment, which comprises an engravable member 54 that is separate from decoration 50. Decoration 50 includes a photo area 51 in which a photo or illustration (not shown) may be affixed, surrounded by a ring 53. First, decoration 50 is affixed to an urn (analogously to the decoration 70 as shown in FIGS. 7 and 8). Then, engravable member 54 is affixed over the top of decoration 50, either to the decoration 50 or directly to the urn, such as by adhesive (not shown) disposed on its rear side at two locations at opposite lateral sides of the decoration 50. This allows the photo to be affixed to the decoration in a single piece, but the engravable member to then cover part of the photo to create a desired aesthetic configuration. Engravable member 54 has engravable area 55 which can be engraved. It is strongly preferred, but not required, to affix the photo to the photo area 51 and to engrave the engravable area 55 before attaching the decoration 50 and the engravable member 54 to the urn. It is optional to have a recessed area or areas in decoration 50 (not shown) into which engravable member 54 fits (or attaches in a mating connection) for ease of relative alignment.

Illustrated in FIG. 6 is a decoration 70 with a photo area 71 according to embodiments. Decoration 70 is curved so that it will conform to the surface of an urn U, as illustrated in FIGS. 7 and 8. An adhesive 77 is applied to the back of decoration 70 such that decoration 70 can then be affixed to the urn. It is preferred, but not required, that a double-sided adhesive be used for ease and efficiency of manufacture. In an embodiment, a double-sided foam tape can be used as adhesive 77, for example of a common type made of urethane foam with acrylic adhesive, and a removable paper liner to expose a rear side.

Shown in FIG. 7 is an illustration of the decoration 70 affixed to an urn U by the adhesive 77, in a method according to another embodiment. Also illustrated in FIG. 7 is an engravable member 74 with an engravable area 75, which is connected to and freely suspended from the main body of the decoration 70 by a pair of chains 78. Because the freely suspended engravable member 74 is not affixed to the urn U, it is not necessary that it conform to the surface of urn U the way the main body of decoration 70 does. In addition, the chains 78 may be detachable from the main body of the decoration 70. This allows the engravable member 74 to be removed, for example to be retained for commemorative or sentimental reasons while the urn U is interred. The curvature of decoration 70 conforming to a surface geometry of urn U is best seen in the lateral side view of FIG. 8.

It is optional, but not required, that decoration 70 (or decoration 10, 20, 30, or 50 any previously described embodiment) be flexible, such as by hand, such that it can conform to a wide variety of urn surfaces and geometries. A benefit of this optional feature is that it is even easier to engrave a decoration if it can be flat (or nearly flat) and can then be conformed to an urn surface geometry after being engraved. Another benefit of this optional feature is the ability of the decoration to be conformed to a broad range of urn surface geometries. A tradeoff is that flexibility may affect the durability of the decoration, and manually flexing a flexible decoration to conform to an urn surface geometry may not result in as closely conforming a fit as when a decoration is permanently formed in the desired geometry, such as by molding.

In yet another embodiment (not shown), instead of applying adhesive to the decoration, the urn incorporates a ferromagnetic material such as iron, or a permanently incorporated magnet. The decoration in turn is either magnetic, has affixed to it a magnet, or incorporates ferromagnetic material which can be magnetically affixed to a magnet incorporated into the urn. This allows the decoration to be removably but securely affixed to the urn, e.g. during a funeral service, and then removed if it is desired to separate them, e.g., because the urn is to be interred but it is desired to retain the decoration for commemorative or sentimental reasons. This also allows the use of decorations on urns during funeral activities, followed by the removal of such decorations after the funeral activities if the participants do not wish to retain them or pay for them. This embodiment may also be incorporated into decorations which are meant to be affixed to urns with flat surfaces.

While various embodiments and aspects of the present invention have been described above, it should be understood that they have been presented by way of example only, and not limitation. Thus, the breadth and scope of the present invention should not be limited by any of the above exemplary embodiments.

This application—taken as a whole with the abstract, specification, and drawings being combined—provides sufficient information for a person having ordinary skill in the art to practice the invention as disclosed herein. Any measures necessary to practice this invention are well within the skill of a person having ordinary skill in this art after that person has made a careful study of this disclosure.

Because of this disclosure and solely because of this disclosure, modification of this device and method can become clear to a person having ordinary skill in this particular art. Such modifications are clearly covered by this disclosure.

It is intended that the scope of the disclosure not be limited by the specification but be defined by the claim(s). In addition, although narrow claims may be presented, it should be recognized that the scope of this disclosure is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional disclosures are not dedicated to the public and the right to file one or more applications to claim such additional disclosures is reserved.

What is claimed is:

1. An engravable adhesive decoration for urns comprising:
a decoration body, the decoration body having an engravable area on a front side of the decoration body; and
a double-sided adhesive, the double-sided adhesive having a front side adhered to a rear side of the decoration body and an exposed rear side, the exposed adhesive rear side being operative to adhere to a surface of an urn to affix the decoration body to the urn.

2. The engravable adhesive decoration for urns of claim 1 wherein the urn has a curved surface geometry, and the decoration body has a curved shape adapted to substantially conform to the curved surface geometry of the urn.

3. The engravable adhesive decoration for urns of claim 1 wherein the urn has a curved surface geometry, and the decoration body is flexible from a flat state to a curved state, the rear side of the decoration body in the curved state having a curved shape adapted to substantially conform to the curved surface geometry of the urn.

4. The engravable adhesive decoration for urns of claim 1 further comprising a removable accessory, the removable accessory being removably affixed to the decoration.

5. The engravable adhesive decoration of claim 4 wherein there is a plurality of removable accessories affixed to the decoration, each of the plurality of removable accessories being independently removable from the decoration.

6. A method of applying an engravable adhesive decoration to an urn, the adhesive decoration comprising a decoration body, the decoration body having an engravable area on a front side of the decoration body, and a double-sided adhesive, the double-sided adhesive having a front side adhered to a rear side of the decoration body and an exposed rear side, the method comprising:
adhering the rear side of the double-sided adhesive to the surface of the urn to affix the decoration body to the urn.

7. The method of claim 6 wherein the decoration body is flexible from a flat state to a curved state, further comprising engraving the engravable area when the decoration body is in the flat state, flexing the decoration body thus engraved to the curved state, and adhering the exposed adhesive rear side to a surface of the urn when the decoration body is in the curved state.
